(19) United States
(12) Patent Application Publication
(10) Pub. No.: US 2008/0054518 A1
(43) Pub. Date: Mar. 6, 2008

(54) Method of manufacturing a stamper

(75) Inventors: Seung-Hyun RA, Seongnam-si (KR); Myeong-Ho HONG, Suwon-si (KR); Hyuk-Soo LEE, Seongnam-si (KR); Jung-Woo LEE, Gunpo-si (KR); Jeong-Bok KWAK, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/896,103

(22) Filed: Aug. 29, 2007

(30) Foreign Application Priority Data
Aug. 31, 2006 (KR) 10-2006-0083305

(51) Int. Cl. B29C 33/38

(52) U.S. Cl. 264/227

(57) ABSTRACT

A method of manufacturing a stamper is disclosed. By using a method that includes: manufacturing a small stamper, in which a first relievo is formed; repeatedly imprinting the small stamper on a large master mold to form a first intaglio corresponding to the first relievo; and molding such that a second relievo is formed, which is in correspondence with the first intaglio, a broad stamper having identical repeated patterns may be manufactured.

### CROSS-REFERENCE TO RELATED APPLICATIONS

This application claims the benefit of Korean Patent Application No. 10-2006-0083305 filed with the Korean Intellectual Property Office on Aug. 31, 2006, the disclosure of which is incorporated herein by reference in its entirety.

### BACKGROUND

1. Technical Field

The present invention relates to a method of manufacturing a stamper, more particularly to a method of manufacturing a broad stamper which has the same patterns repeated.

2. Description of the Related Art

In step with the societal demands of the twenty first century for high-tech information and communication, electronics and electrical technology has seen rapid advances towards greater storage capacities, faster information processing and transmission, and more convenient information communication networks.

In particular, under the condition of finiteness in information transmission speeds, the method is being suggested of generating new functionalities by implementing the components to be as small as possible while increasing reliability, as a way to meet such requirements.

As described above, with the trends towards lighter, thinner, and simpler electronic products, so also is the printed circuit board trending towards finer patterns, smaller sizes, and more packaged products. Thus, in order to implement circuits having greater signal processing capabilities in a narrower area, there is a need for manufacturing high-density boards (e.g. line/space ≦10 μm/10 μm, microvia <30 μm).

One of the most widely used technology for fabricating minute structures is UV lithography, which is a method of irradiating ultraviolet rays on a board coated with a photoresist thin film to form circuit patterns.

However, manufacturing a board using the UV lithography method may have the limitations that the copper foil must be thick and that wet etching must be used, whereby the reliability of the products may be degraded when using UV lithography to form fine patterns with a pitch of 10 μm or less.

Recent times are seeing printed circuit boards with greater levels of integration, and accordingly, there is active ongoing research on methods of forming fine patterns. Thus, much attention is being given to attempts at manufacturing high-density boards using a stamper for forming circuit patterns, as an alternative process to the UV lithography method described above.

A stamper is commonly fabricated by nickel electroforming or by polymer molding, and in order to manufacture a stamper using such methods, a master mold may be required that has the desired patterns formed in intaglio.

The master mold may be made by etching processes applied on Si wafers, etc., where the maximum area of a stamper would be limited to the size of the wafer. One method of using a small stamper to form circuit patterns having repeating patterns is to use UV-setting resin. The so-called “step & repeat” technique includes imprinting a stamper in a resin to form a pattern, irradiating UV rays to cure the resin, and then repeating the same procedures for the next section. This, however, may lead to long processing times.

Another technique is to imprint a stamper in thermosetting resin, but in this case, the imprint processing area relies entirely on the area of the stamper used.

For ultrafine (nanosized) patterns, it is possible to use processing methods that utilize electron beams or FIB's (focused ion beams), etc., but these entail excessively long processing times and high costs.

### SUMMARY

An aspect of the invention is to provide a method of manufacturing a broad stamper having the same relievo pattern repeated, using a small stamper having fine patterns.

One aspect of the claimed invention provides a method of manufacturing a stamper, which includes: manufacturing a small stamper, in which a first relievo is formed; repeatedly imprinting the small stamper on a large master mold to form a first intaglio corresponding to the first relievo; and molding such that a second relievo is formed, which is in correspondence with the first intaglio.

In certain embodiments, the operation of manufacturing the small stamper may include removing a portion of a small master mold to form a second intaglio, and molding such that the first relievo is formed in correspondence with the second intaglio.

In certain embodiments, the operation of molding such that the first relievo is formed may include molding the inside of the second intaglio by nickel electroforming or by polymer molding, and removing the small master mold to manufacture the small stamper in which the first relievo is formed.

The molding such that the second relievo is formed may include filling an inside of the first intaglio by nickel electroforming or by filling with a polymer, and removing the large master mold to manufacture the broad stamper in which the second relievo is formed.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a flowchart of a process for manufacturing a small stamper according to a first disclosed embodiment of the invention.

FIG. 2a is a flow diagram of a process for manufacturing a small stamper according to a first disclosed embodiment of the invention.

FIG. 2b is a flow diagram of a process for manufacturing a small stamper according to a second disclosed embodiment of the invention.

FIG. 3 is a flowchart of a process for manufacturing a broad stamper according to a third disclosed embodiment of the invention.

FIG. 4 is a flow diagram of a process for manufacturing a broad stamper according to a third disclosed embodiment of the invention.

FIG. 5 is a plan view of a broad stamper according to a fourth disclosed embodiment of the invention.

### DETAILED DESCRIPTION

The method of manufacturing a stamper according to certain embodiments of the invention will be described below in more detail with reference to the accompanying drawings, in which those components are rendered the same reference numeral that are the same or are in correspondence, regardless of the figure number, and redundant explanations are omitted.

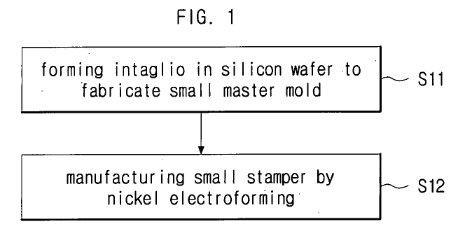

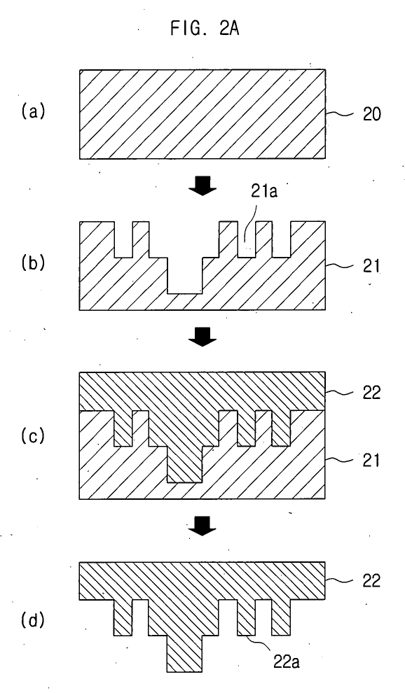

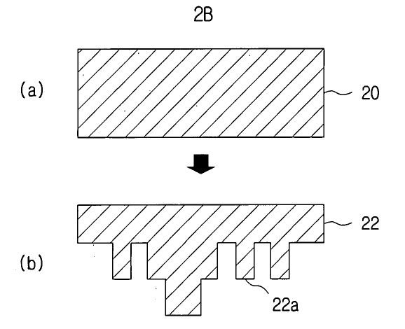

FIG. 1 is a flowchart of a process for manufacturing a small stamper according to a first disclosed embodiment of the invention, and FIG. 2a is a flow diagram of a process for manufacturing a small stamper according to the first disclosed embodiment of the invention. In FIG. 2a are illustrated a silicon wafer 20, a small master mold 21, an intaglio 21a, a small stamper 22, and a relievo 22a.

Operation S11 of FIG. 1 may be to form the intaglio 21a in the silicon wafer 20 to fabricate the small master mold 21, where drawings (a) and (b) of FIG. 2 represent the corresponding processes. The method of forming the intaglio 21a may be in the same manner as for a semiconductor etching process. This is to facilitate the forming of an ultrafine-sized intaglio 21a. Thus, other processes may just as well be used, as long as they provide the same results. Also, silicon dioxide (SiO2), quartz, etc., may be used for the material of the small master mold 21, within a range that allows an easy implementation of the ultrafine size intaglio 21a.

Operation S12 of FIG. 1 may be to manufacture the small stamper 22 by nickel electroforming, where drawings (c) and (d) of FIG. 2 represent the corresponding processes. Nickel electroforming may be performed in the inside of the intaglio 21a of the small master mold 21. Afterwards, when the small master mold 21 is separated, as in (d) of FIG. 2, the small stamper 22 may be manufactured. This small stamper 22 may have a form that is in correspondence with the intaglio 21a of the small master mold 21. Thus, when imprinting the small stamper 22, the imprinted form may be identical to the form of the intaglio 21a.

A reason for using nickel as the material for the small stamper 22 is because it is easier to handle than are other metals, and because it has superb ductility, so that it is not easily fractured when undergoing repeated imprinting. Thus, other materials, such as polymers, may just as well be used, as long as they provide the same properties.

FIG. 2b is a flow diagram of a process for manufacturing a small stamper 22 according to a second disclosed embodiment of the invention, which represents a process in which a silicon wafer 20 is etched to manufacture a small stamper 22 having the relievo 22a formed. This may be a more direct method of manufacturing the small stamper 22 than is the method described with reference to the first disclosed embodiment in FIG. 2a, but since the material used is silicon, there may be low durability when proceeding with the subsequent process of repeated imprinting. However, in cases where high durability is not required in proceeding with the imprinting process, this may be an effective method of manufacturing the small stamper 22, because of its simplicity.

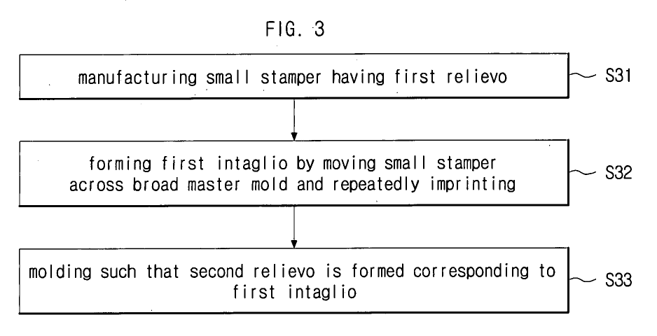

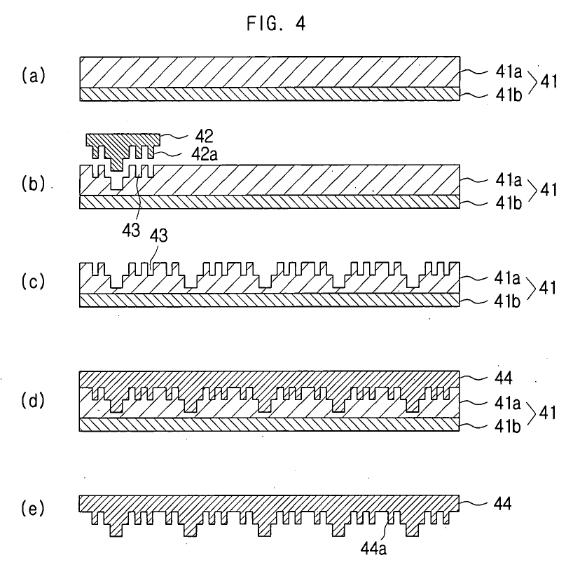

FIG. 3 is a flowchart of a process for manufacturing a broad stamper according to a third disclosed embodiment of the invention, and FIG. 4 is a flow diagram of a process for manufacturing a broad stamper according to the third disclosed embodiment of the invention. In FIG. 4 are illustrated a large master mold 41, resin 41a, a substrate 41b, a small stamper 42, a first relievo 42a, a first intaglio 43, a broad stamper 44, and a second relievo 44a.

Operation S31 of FIG. 3 may be to manufacture the small stamper 42 in which the first relievo 42a is formed, which has already been sufficiently described with reference to the first and second disclosed embodiments.

Operation S32 of FIG. 3 may be to form the first intaglio 43 by moving the small stamper 42 across the broad master mold 41 and repeatedly imprinting, where drawings (a), (b), and (c) of FIG. 4 represent the corresponding processes. The broad master mold 41 may have the form of resin 41a stacked on the substrate 41b. The substrate 41b may serve as a reinforcing material that supports the resin 41a. The material for such a substrate 41b may be silicon (Si), silicon dioxide (SiO2), glass, or quartz, etc. The resin 41a may be the portion where the relievo 42a of the small stamper 42 is imprinted to form the first intaglio 43. The resin 41a resin may be PMMA (polymethyl methacrylate) with a stiffening agent added in, or may be a film of a transparent material that can be cured by UV rays.

When this large master mold 41 is prepared as in (a) of FIG. 4, the small stamper 42 provided beforehand may move and repeatedly imprint in the large master mold 41, as in (b) of FIG. 4. As a result, the large master mold 41 may be completed with the first intaglio 43 formed, which has repeating patterns, as is shown in (c) of FIG. 4.

Operation S33 of FIG. 3 may be of molding such that the second relievo 44a which corresponds with the first intaglio 43, where (d) and (e) of FIG. 4 are the corresponding drawings. As in (d) of FIG. 4, plating may be performed, by nickel electroforming, to fill the insides of the large master mold 41. Of course, other metals besides nickel may just as well be used. Also, other materials besides metals may be used, such as polymers, as long as they provide the same properties.

When the large master mold 41 is separated, a broad stamper 44 may be obtained, such as that shown in (e) of FIG. 4. In the broad stamper 44 may be formed a second relievo 44a, which may have a form that is identical to several of the first relievo 42a of the small stamper 42 coupled together.

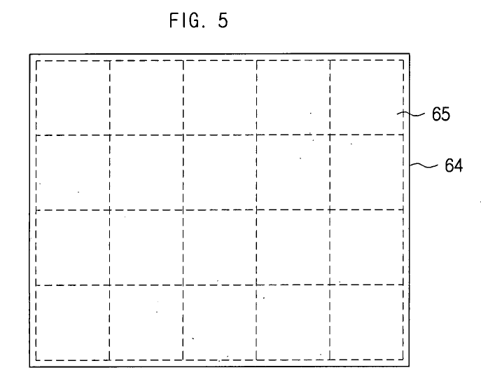

FIG. 5 is a plan view of a broad stamper according to a fourth disclosed embodiment of the invention. In FIG. 5 are illustrated a broad stamper 64, and pattern units 65. As FIG. 5 is a plan view, only the top of the broad stamper 64 is illustrated. At the bottom, there may be formed a second relievo 44a such as that shown in FIG. 4. Since this second relievo 44a may be made by repeatedly imprinting the same small stamper 42, identical patterns may be repeated with the dotted lines as boundaries. Such a pattern in the repeated form will be referred to as the pattern unit 65. While FIG. 6 illustrates a configuration of twenty pattern units 65, the number may be varied as necessary.

According to a certain aspect of the claimed invention as set forth above, a small stamper made by nickel electroforming on a silicon wafer can be repeatedly imprinted to manufacture a broad stamper, so that ultrafine patterns can be formed. By using such a broad stamper, a printed circuit board having identical patterns can be formed at once, when forming circuit patterns by imprinting processes, so that the printed circuit board may be manufactured easily.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A method of manufacturing a stamper, the method comprising:
manufacturing a small stamper having a first relievo formed therein;
repeatedly imprinting the small stamper on a large master mold to form a first intaglio corresponding to the first relievo; and
molding such that a second relievo is formed, the second relievo being in correspondence with the first intaglio.

2. The method of claim 1, wherein manufacturing the small stamper comprises:
removing a portion of a small master mold to form a second intaglio; and
molding such that the first relievo is formed in correspondence with the second intaglio.

3. The method of claim 2, wherein molding such that the first relievo is formed comprises:
molding an inside of the second intaglio by any one of nickel electroforming and polymer molding; and
removing the small master mold to manufacture the small stamper having the first relievo formed therein.

4. The method of claim 1, wherein molding such that the second relievo is formed comprises:
filling an inside of the first intaglio by any one of nickel electroforming and polymer filling; and
removing the large master mold to manufacture a broad stamper having the second relievo formed therein.
